(19) United States
(12) Patent Application Publication
(10) Pub. No.: US 2008/0189148 A1
(43) Pub. Date: Aug. 7, 2008

(54) GROUND TRANSPORTATION BOOKING

(76) Inventors: Jason Diaz, New York, NY (US); Anthony Bonnano, Ramsey, NJ (US)

Correspondence Address: STRATEGIC PATENTS P.C.., C/O PORTFOLIOIP, P.O. BOX 52050, MINNEAPOLIS, MN, 55402, US

(21) Appl. No.: 12/027,483

(22) Filed: Feb. 7, 2008

Related U.S. Application Data
(60) Provisional application No. 60/888,614, filed on Feb. 7, 2007.

(51) Int. Cl. G06Q 50/00

(52) U.S. Cl. 705/6

(57) ABSTRACT

The systems and methods disclosed herein provide improved comparison and booking of ground transportation travel purchases addressing taxis, limos, shared rides, parking, and other related travel categories, through a single point of purchase. Using its own application programming interface (“API”) to connect to various ground transportation content providers, an automated multi-transportation mode system may gather ground transportation data from various service providers, and may assist travelers in securing reservations and bookings of all ground travel. The multi-mode ground transportation system described herein may provide integration and sharing of prices, reservations, bookings and other related information provided by disparate ground content providers. A data network such as the Internet and World Wide Web may be used as the data distribution backbone between the distribution partners and the multi-mode ground transportation network, and may further support integrated presentation to an end user who is making travel arrangements.

### CROSS-REFERENCE TO RELATED APPLICATIONS

This application claims the benefit of U.S. Provisional Application No. 60/888,614 filed on Feb. 7, 2007, the entire content of which is incorporated herein by reference in its entirety.

### BACKGROUND

1. Field

The present invention generally relates to booking ground transportation, and more specifically to facilitating the comparison, selection, and booking of ground transportation from among multiple modes and vendors of ground transportation services.

2. Background

Travel planning can be complicated and time consuming. A travel planner must select among various modes of travel (e.g., air, rail), and typically must select hotel or other accommodations at a destination. While various consumer-oriented tools have emerged to assist a travel planner with major travel purchases, little has been done to assist travelers with interstitial travel arrangements such as how a traveler gets to and from airports, hotels, and the like (except perhaps for car rentals, which account for a small fraction of all such transactions). There remains a need for improved comparison, selection, and booking tools that embrace a variety of modes of ground transportation.

### SUMMARY

The systems and methods disclosed herein provide improved comparison and booking of ground transportation travel purchases addressing taxis, limos, shared rides, parking, car rentals, and other related travel categories, through a single point of purchase. Using its own application programming interface (“API”) to connect to various ground transportation content providers, an automated multi-transportation mode system may gather ground transportation data from various service providers, and may assist travelers in securing reservations and bookings of all ground travel. The multi-mode ground transportation system described herein may provide integration and sharing of prices, reservations, bookings and other related information provided by disparate ground content providers. A data network such as the Internet and World Wide Web may be used as the data distribution backbone between the distribution partners and the multi-mode ground transportation network, and may further support integrated presentation to an end user who is making travel arrangements.

In one aspect, a method disclosed herein provides for comparing the price of multiple modes of ground transportation simultaneously, and then selecting and booking the preferred mode of transportation in an automated fashion. Global Distribution Systems (“GDS”) used by travel agents, Travel Portals (“Portals”) used by consumers and/or travel agents, and the like may offer this multi-mode ground transportation network to customers. In another aspect, ground transportation services may be offered separately and directly to consumers using the data acquired from various ground transportation service providers.

In one aspect, a method disclosed herein includes acquiring ground transportation data from a plurality of service providers; receiving travel itinerary data from a client; applying the travel itinerary data to the ground transportation data to obtain a plurality of ground transportation options, each one of the plurality of ground transportation options including a transportation mode wherein the plurality of ground transportation options includes at least two different modes of transportation; and transmitting the plurality of ground transportation options to the client for display in a ground transportation matrix that includes, for each one of the ground transportation options, an icon depicting the transportation mode, an estimated price for the transportation mode, and a link to additional information for the one of the ground transportation options.

Additional information may include a number of ground transportation offerings from one of the plurality of service providers. The method may include receiving a selection of one of the plurality of ground transportation options from the client, thereby providing a selected ground transportation service; and preparing a travel itinerary that includes the selected ground transportation service. The method may include booking the selected ground transportation service. The method may include processing a payment for the selected ground transportation service. The method may include storing the travel itinerary and providing an in-transit user interface for retrieving details of the travel itinerary. The in-transit user interface may include one or more of an electronic mail interface, a short messaging service interface, an instant messaging interface, and a web interface. The client may include a stand-alone consumer interface for booking ground transportation. The client may include a travel planning Web portal that provides a consumer interface for obtaining travel reservations. The at least two different modes of transportation may include one or more of a bus, a taxi, a water taxi, a limousine, a subway, a rental car, and a commuter rail. The link to additional information for the one of the ground transportation options may include a link to one or more of a rental car company web site, a private car service web site, and a public transportation web site. The method may include receiving a selection of one of the plurality of ground transportation options from the client, thereby providing a selected ground transportation service; and adjusting a price for one or more providers of the selected ground transportation service based upon historical data, thereby providing adjusted prices; and transmitting the adjusted prices to the client for display. The link to additional information for one of the ground transportation options may provide a list of a plurality of service providers for the one of the ground transportation options. The method may include sorting the plurality of ground transportation options in the ground transportation matrix according to one or more of cost and speed. Applying the travel itinerary data to the ground transportation data to obtain a plurality of ground transportation options may include applying a corporate travel policy to determine available ground transportation options. Applying the travel itinerary data to the ground transportation data to obtain a plurality of ground transportation options may include determining a membership of a user in a group, and using the membership to determine available ground transportation options. Applying the travel itinerary data to the ground transportation data to obtain a plurality of ground transportation options may include determining a membership of a user in a group, and using the membership to locate one or more discounts for the plurality of ground transportation options.

In another aspect, a method of enforcing corporate travel policies disclosed herein includes presenting a plurality of ground transportation alternatives to a user; receiving a selection of one of the ground transportation alternatives from the user; and selectively accepting the selection only when it conforms to a corporate travel policy.

The corporate travel policy may specify a cost for ground transportation. The corporate travel policy may specify one or more providers of ground transportation service.

### DRAWINGS

The inventions disclosed herein may be more clearly understood with reference to the accompanying drawings, wherein:

FIG. 1 shows an architecture for a ground transportation booking system.

FIG. 2 shows a process for obtaining ground transportation mode prices.

FIG. 3 shows a process for presenting ground transportation mode prices to a client.

FIG. 4 shows a user interface for a ground transportation booking system.

FIG. 5 shows a user interface for a ground transportation booking system.

FIG. 6 shows a user interface for a ground transportation booking system.

FIG. 7 shows a user interface for a ground transportation booking system.

### DETAILED DESCRIPTION

“Ground transportation services” or similar terms, as used herein, will be understood to include limousines, taxis, shared taxis, parking, shuttles, busses, subways, water taxis, rental cars, and the like, as well as any other related services.

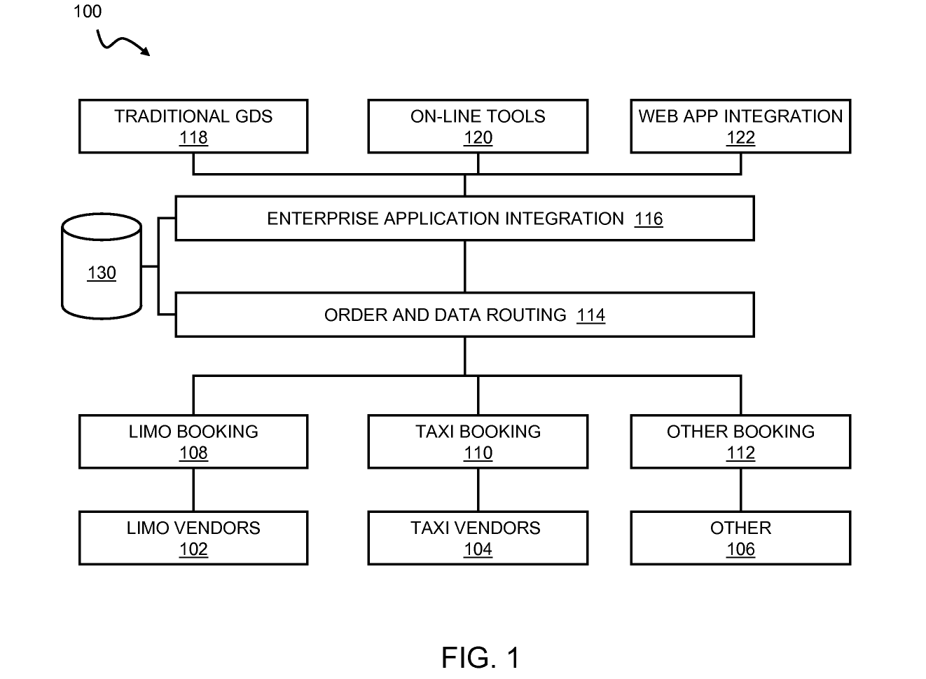

FIG. 1 shows an architecture for a ground transportation booking system. In general, the system 100 includes limousine vendors 102, taxi vendors 104, and other ground transportation providers 106 such as rental companies, parking garages, shuttles, subways, and so forth. Each vendor or network of vendors has a booking service such as a limo booking switch 108, a taxi booking switch 110, or a booking switch 112 for one or more other providers. These booking switches may be integrated through a high-level order and data routing service 114, which may be exposed to various uses through an application integration layer 116. This layer 116 may in turn be used by a traditional Global Distribution System (“GDS”) 118 including commercially available services such as Worldspan, Sabre, or Galeleo. The application integration layer 116 may also, or instead, be used with various on-line tools 120 and providers such as Cliqbook, GetThere or the like. The application integration layer 116 may also be used for custom web applications 122 such as corporate in-house travel planning tools or branded booking/reservation systems.

In general, the order and data routing service 114 serves as an aggregator of availability, pricing and booking information for a variety of ground transportation services. By way of example and not limitation, this may include limousine vendors 102, taxi vendors 104, and other ground transportation providers 106 such as parking providers, car rental companies, busses, subways, water taxis, and so forth. Each mode of ground transportation may be aggregated by a commercial booking provider, depicted generally as a limo booking switch 108 (e.g., GroundScope), a taxi booking switch 110 (e.g., TaxiPass), and other booking 112, each of which may include one or more commercial services that represent individual providers, and/or independent or jointly-owned booking service providers. Thus for each mode a number of different vendors may provide data concerning prices, availability, offerings, and so forth using various communications methods that may include facsimile, mail, electronic mail, secure network connections, or any other suitable technique for communicating information. In general, the booking provider synthesizes data from disparate vendors and provides a common XML or other format for conducting transactions. The order and data routing service 114 then communicates with each of these vendors to provide a single point of contact for information and booking across a variety of ground transportation modes.

The order and data routing service 114 may, in turn, offer content through an enterprise application integration (“EAI”) service 116 to a variety of intermediaries who offer reservation/booking services to customers. The EAI service 116 may act as a common interface that provides aggregated price and booking options to potential travel purchasers, and then routes selected mode reservations and bookings to appropriate ground transportation service providers. The EAI service 116 may provide a front end accessible using a toll-free telephone number, GDS script, online booking tool, White Label web link or email. More generally, the EAI service 116 may provide a variety of interface and communication formats to accommodate different users and different deployment contexts. Using the EAI front end, travelers may add ground transportation to a travel booking. As a significant advantage, using the systems and methods described herein, a traveler can automatically compare alternative modes of transportation easily, and then reserve a selected mode with ease.

In one aspect, the ground transportation booking system 100 may use a database 130 to store information concerning a user, such as information provided during a related hotel or airline reservation process, or information contained in a customer profile for the traveler. This may alleviate the need for a traveler to manually provide travel information such as a destination, time and date of travel, home address, billing information, and so forth. The database 130 may also store a variety of information relating to travel transactions including, for example, corporate travel policies, user information, travel history, vendor pricing information, and so forth. In one aspect, the database 130 collects and stores information related to current travel reservations, and provides an interface through the EAI service 116 for users to obtain in-transit reservation details using an electronic mail interface, a short messaging service interface, an instant messaging interface, a web interface, or the like.

Although not depicted, it will be understood that numerous subsystems may be included in a ground transportation booking system as described herein. For example, the system may include a payment processing system for processing electronic payments and/or billing existing accounts for ground transportation services. One or more corporate enterprise applications or databases may be securely accessed and used to support travel policy enforcement, traveler information, and so forth. The system 100 may also provide billing, costing, or other information directly to a corporate enterprise application for internal use by a corporate customer.

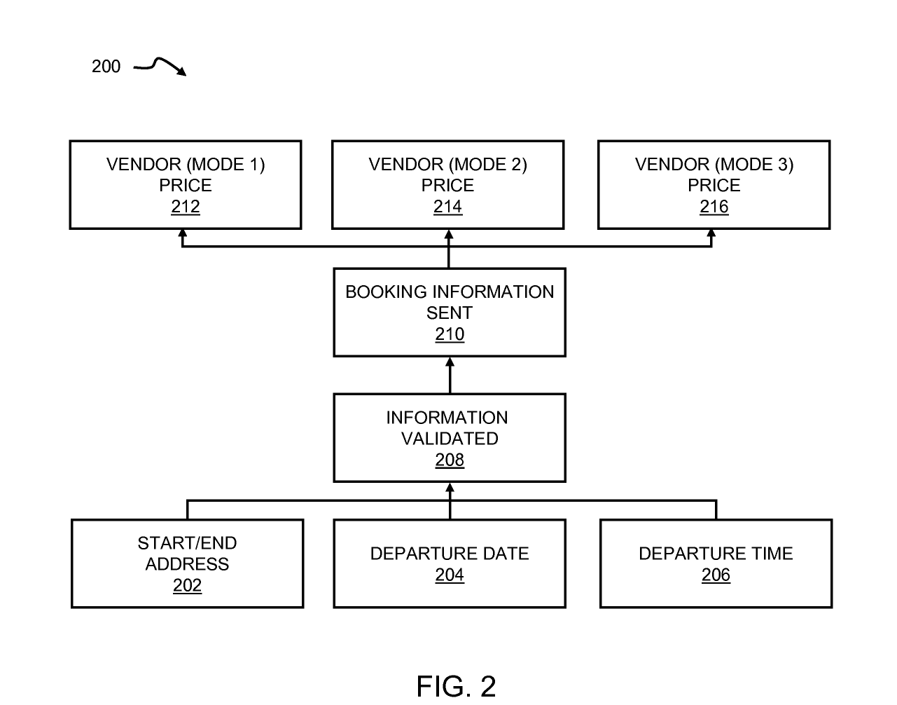

FIG. 2 shows a process for obtaining ground transportation mode prices, which may be performed for example, within the order and data routing service 114 and EAI service 116 of FIG. 1. In general the process 200 begins with a receipt of booking data such as a starting/ending address 202, a departure date 204, and a departure time 206.

As shown in step 208, the booking information may be validated and supplemented as appropriate with other travel details (e.g., air travel information). In this step, the booking information may also be compared to corporate travel policies, personal preferences, and the like in order to preselect specific modes or provide criteria for booking requests.

As shown in step 210, the booking information may then be sent to a variety of service providers to obtain current price/availability information. This may result in a number of ground transportation price options being returned, such as a first vendor price 212 for a first mode of transportation (e.g., private car service), a second vendor price 214 for a second mode of transportation (e.g., taxi), and a third vendor price 216 for a third mode of transportation (e.g., park and ride).

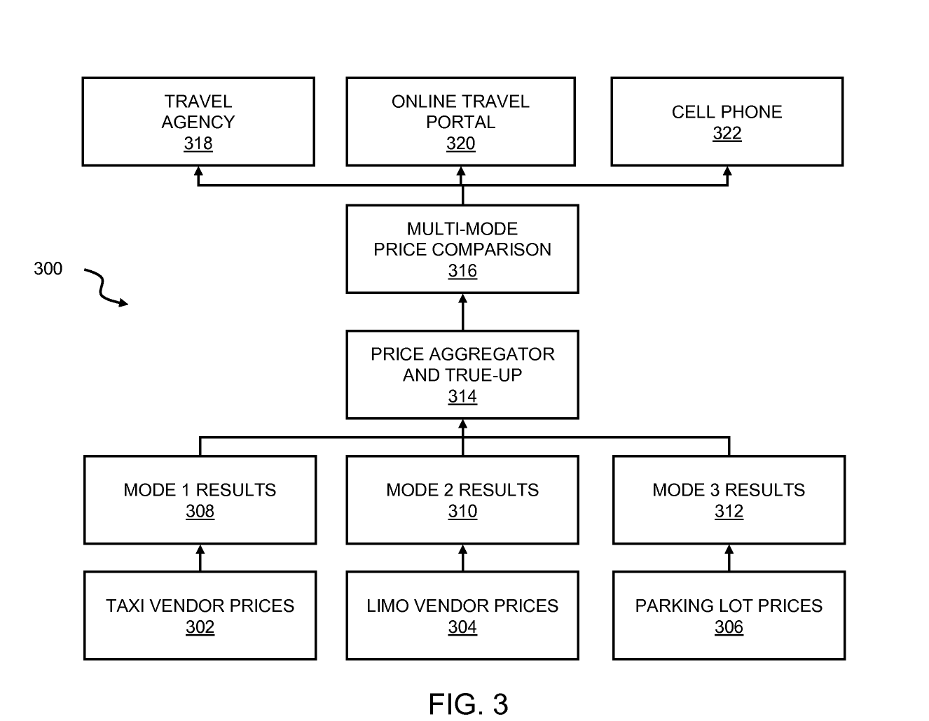

FIG. 3 shows a process for presenting ground transportation mode prices to a client. In general, the process 300 begins with a number of taxi vendor prices 302 being integrated into results 308 for a first (taxi) mode of ground transportation, a number of limo vendor prices 304 being integrated into results 310 for a second (limo) mode of ground transportation, and a number of parking lot prices 306 being integrated into results 312 for a third (parking) mode of ground transportation. It will be understood that while three specific modes of ground transportation are depicted, any number of different modes of transportation may be included in the systems and methods described herein. This may include, for example, public transportation prices, car rental prices, and so forth, according to the various modes of transportation available at a departure or arrival location.

As shown in step 314, the individual ground transportation mode results may be aggregated and trued-up according to known or historical price deviations from particular vendors, or for particular modes of transportation. Thus, the system may improve the accuracy of cost comparisons by accounting for various costs of each option. For example, various rules may be employed when estimating the total cost of a particular option. By way of example and not of limitation, taxi prices may include base fare as well estimated taxes, tolls, gratuity, and other fees. Limousine prices may include base fare as well as estimated taxes, tolls, waiting time, gratuity, and other fees. Shuttle prices may include base fare as well as estimated taxes, tolls, gratuity and other fees. Car rental prices may include base fare plus estimated taxes, fees, gas, insurance cost, parking and other fees. Parking prices may include base fees as well as cost of roundtrip mileage. These and other factors may be taken into account when estimating the total cost of one or more of the ground transportation options presented using the systems and methods described herein.

As shown in step 316, the aggregated and trued-up prices may be compiled into a multi-mode matrix for more accurate, side-by-side comparison. As a significant advantage, providing price information and other details for various ground transportation modes within the EAI service 116 and order and data routing service 114 permits the system to create and display a single, integrated, multi-mode matrix with price information. With this matrix, a user may compare prices and other details within a single display, while retrieving more detailed information for each mode of transportation, and various providers for same, using hyperlinks or the like within the multi-mode matrix. The multi-mode matrix may be further processed according to any available information. For example, matrix results may be sorted according to cost, speed, quality rating, or any other available criteria. The multi-mode matrix may be filtered according to a corporate travel policy to remove ground transportation options that do not comply with the policy, or to require explicit approval for non-complying reservations. Other user information, such as an affiliation or group membership may be employed to include discounts or special promotions within the ground travel options in the matrix. More generally, a variety of business rules, filters, application logic, and the like may be applied to customize a matrix to a particular user or entity. All such variations as would be known to one of ordinary skill in the art are intended to fall within the scope of this disclosure.

Thus in one aspect there is disclosed herein a method of enforcing corporate travel policies that includes presenting a plurality of ground transportation alternatives to a user, receiving a selection of one of the ground transportation alternatives from the user, and selectively accepting the selection only when it conforms to a corporate travel policy. In general, the corporate travel policy may specify a cost for ground transportation, one or more authorized providers of ground transportation service, authorized modes of ground transportation service, or any other items.

The travel policy may be stored either within a corporate network or in the database 130 or other data storage facility associated with the EAI service 116 or other component of the system 100. The availability of the corporate travel policy provides opportunities for significant enhancements to preparation of the multi-mode transportation matrix. For example, the corporate travel policy may specify options that are outside the policy, and may either proactively remove these from the matrix before presentation to a user, or present the out-of-policy options in the matrix along with a warning or the like that prevents user selection. In one embodiment, the matrix may request a user-supplied reason for any selection that is outside the policy, or may initiate a request for authorization from appropriate corporate personnel.

The travel policy may contain a wide range of corporate information. This may include definitions of various employee levels (e.g., senior management, middle management, non-management employees, etc.), definitions of out-of-policy options (e.g., an employee-level or corporate-wide restriction on various modes of ground transportation), and acceptable reasons for selecting out-of-policy options. The policy may also include corporation or user specific true-ups to provide customized pricing based upon corporate discounts, promotional programs, and so forth. An interface may be provided for authorized users to configure, modify, or otherwise edit a corporate travel policy. In addition, a wide variety of reports may be provided relating to usage by corporate personnel, including costs, policy exceptions, and/or other comparative or personal usage data as well as the relationship of any of the foregoing to travel policies.

The creation and implementation of travel policies, along with reporting of expenses and compliance for travel, is one significant advantage that can be realized with the integrated system described herein. More generally, the integration of personal data, travel histories, corporate policies, and other user information into a single ground transportation booking system provides opportunities for a wide variety of additional cost savings and trip planning improvements. For example, the system may receive information from airline databases relating to flight schedules, and may generate alerts when flight times have been altered or flights have been cancelled. In one aspect, this information may be used to automatically revise ground transportation reservations. Similarly, news feeds concerning inclement weather or other items likely to cause travel delays may be received and processed within the system to provide notifications and/or reschedule ground transportation reservations. The system may also automatically create new reservations when a booked reservation is compromised due to service interruptions, over-booking, or other events. More generally, any advantageous use of integrated travel itinerary, corporate travel policy, personal information, and other external data may be implemented using the platform described herein, and all such variations as would be apparent to one of ordinary skill in the art are intended to fall within the scope of this disclosure.

The multi-mode price comparison may be presented to end users through a variety of communication channels. For example, the matrix may be displayed at a travel agency as shown in step 318, an online travel portal as shown in step 320, or a cellular phone or other portable electronic device as shown in step 322.

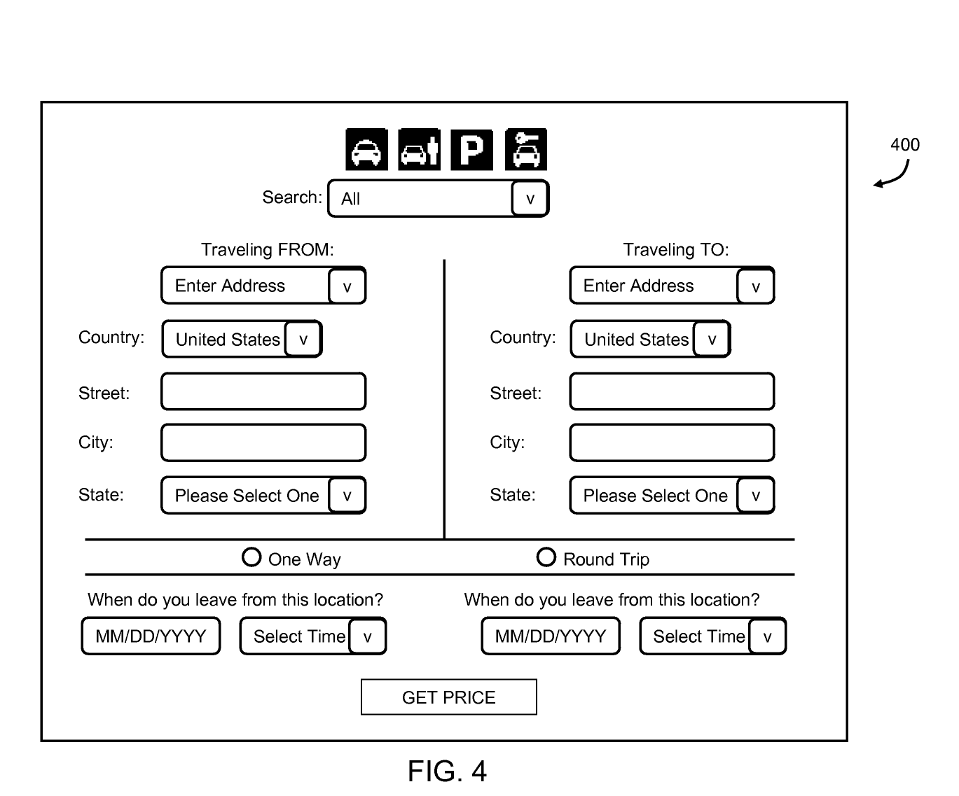

Turning now to the multi-mode matrix, FIG. 4 shows a user interface for a ground transportation booking system. More specifically, the figure depicts an interface for entering information to generate a multi-mode ground transportation comparison. In one aspect, multi-mode ground transportation content may be offered to a traveler automatically after the traveler has reserved an air or hotel segment, or at any time after adequate data has been entered to present ground transportation options. The interface 400 may request various booking particulars directly from the traveler, or the interface 400 may retrieve data from other booking entries (such as after the traveler enters beginning and ending locations, date and times for travel). From this information, a multi-mode transportation matrix may be created for presentation to the traveler as generally described above.

To offer a multi-mode transportation comparison matrix, the following pieces of data may be requested through the user interface 400: pick up location; drop off location; pick up date/time; return date/time; and any other suitable or useful information. Some or all of this information can be automatically received from various sources such as an existing airline or hotel reservation, user profile information such as an address, and so forth. With such information, pricing can be calculated for getting to/from those locations specified within a travel itinerary using ground transportation modes such as a taxi, a limousine, a sedan, a shared ride, a car rental, and parking.

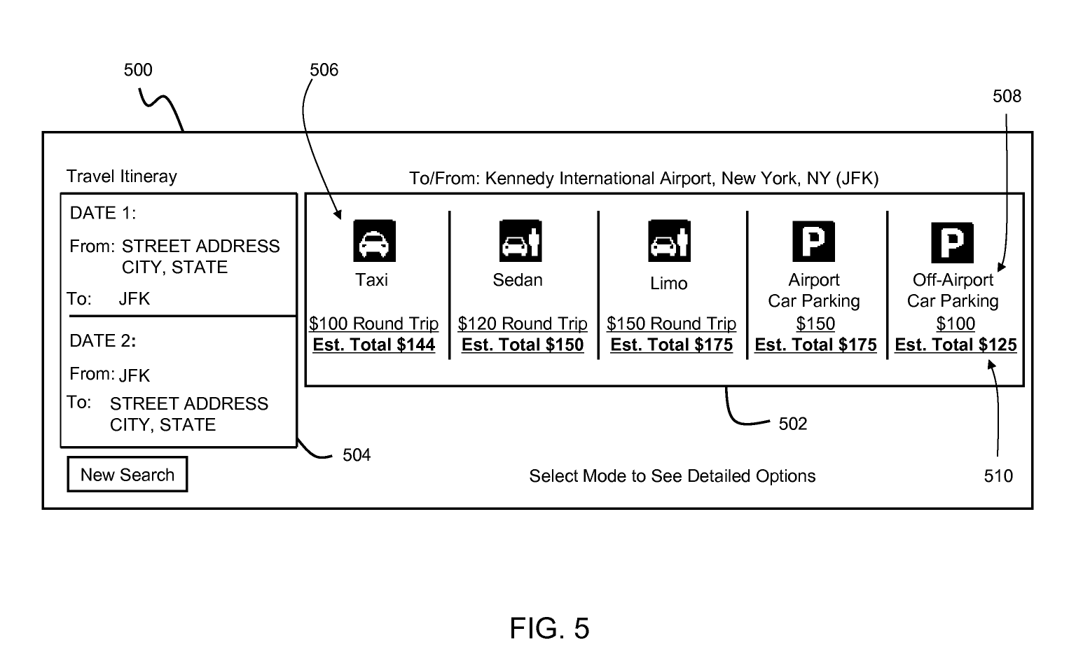

FIG. 5 shows a user interface for a ground transportation booking system. In this interface 500, a user may select a preferred mode of transportation to an airport using a multi-mode matrix. In general, the matrix 502 may be prepared using the systems and methods described above. Where available, other travel itinerary information 504 may also be displayed. As noted above, if a person booked an airline ticket and a hotel reservation, and had their home address in a profile, the computer may automatically price all available transportation modes to and from the departing airport to prepare the multi-mode transportation matrix 502. The matrix 502 may present summary information such as an icon 506 depicting the mode of transportation, a brief description 508 of the mode of transportation, and price information 510 such as a base price, an estimate of total cost for each mode after including all taxes, gratuities, mileage, fees, tools, extras, and so forth (including true-ups, as appropriate).

While FIG. 5 depicts several specific modes of ground transportation, it will be understood that other modes may also, or instead, be depicted according to, e.g., transportation options available from a particular location. These options may include, for example, a water taxi, a bus, a subway, a car rental, a taxi, a limousine, and one or more parking areas.

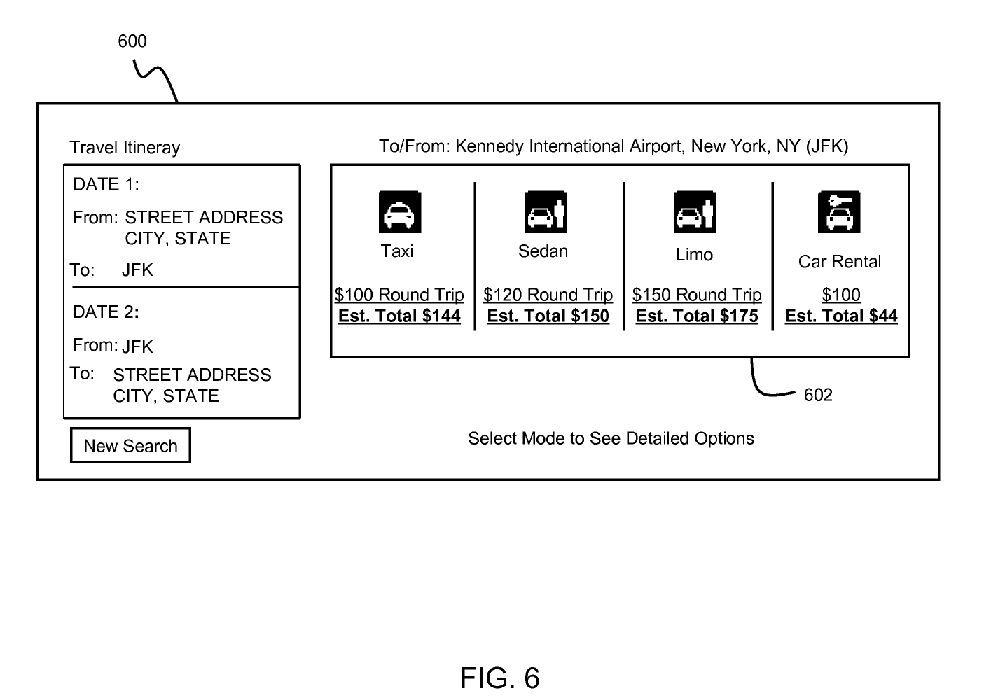

FIG. 6 shows a user interface for a ground transportation booking system. In particular, the figure depicts a user interface 600 that may be used for selecting a preferred mode of transportation from an airport to a final destination using a multi-mode matrix 602. As may be readily appreciated by a comparison of FIG. 5 to FIG. 6, one location may have different ground transportation options than another. In addition, the matrix may include certain default selections (which may or may not be altered by a user depending upon a particular deployment). For example, a destination may automatically be populated with any available car rentals, while the departure location may automatically exclude car rental options. These variations may be determined according to user preferences, corporate travel policy, or any other information available within the database 130 described above.

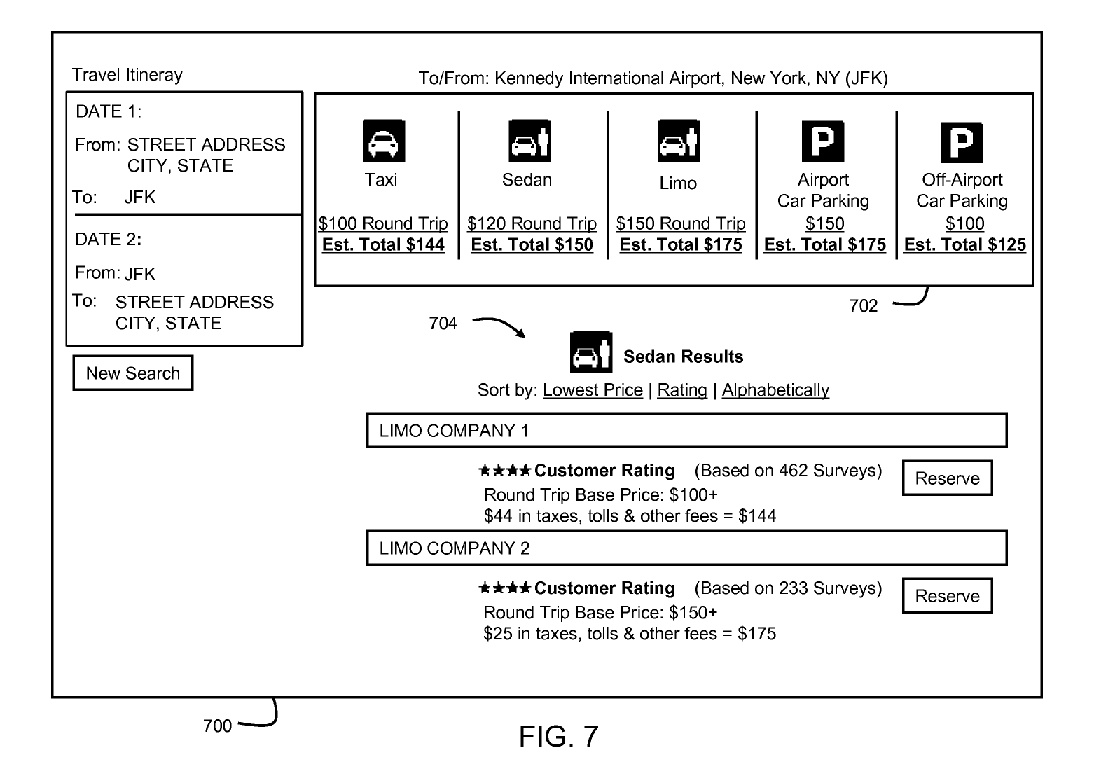

FIG. 7 shows a user interface for a ground transportation booking system. In particular, FIG. 7 shows user interface 700 including a ground transportation matrix 702, along with details 704 a particular ground transportation option including, for example, offerings from a number of service providers and a hyperlink to a page for making corresponding reservations. In general operation, a user may request more details for a particular option using any suitable interface operation, such as by clicking on an icon, hyperlink, or other active area of the interface corresponding to the particular ground transportation option. The system may respond by presenting one or more providers, along with any additional detail information and a button or other control to reserve services from each provider. The details 704 may, for example, include links to rental car company web sites, private car service web sites, public transportation web sites, and the like, or may encapsulate information from these sources within the user interface 700.

Using either the ground transportation booking system, or an interface provided directly by the ground transportation service provider, the user may then reserve specific ground transportation. In one embodiment, the ground transportation multi-mode matrix 700 may be automated, and may use any information previously provided by the traveler for the travel booking(s), or other information associated with the traveler in a user profile, corporate account, or the like.

Once services are purchased a unified itinerary may be created for the traveler including the ground transportation details booked through the system described herein. As noted above, the travel booking features described herein may be deployed through a corporate travel portal, a travel agent web site, or a consumer site, or otherwise integrated into other service offerings and/or branded by travel service providers.

Other aspects of a ground transportation booking system will be understood with reference to the appendix hereto, which forms a part of this disclosure. This includes, without limitation, techniques for enforcing corporate travel policies with respect to travel generally, and ground transportation in particular.

It will be appreciated that the above systems and methods may be realized in hardware, software, or any combination of these suitable for a publicly accessible booking system described herein. This includes realization in one or more microprocessors, microcontrollers, embedded microcontrollers, programmable digital signal processors or other programmable devices, along with internal and/or external memory. The may also, or instead, include one or more application specific integrated circuits, programmable gate arrays, programmable array logic components, or any other device or devices that may be configured to process electronic signals. It will further be appreciated that a realization may include computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. At the same time, processing may be distributed across devices such as a web server, ground transportation service provider servers, travel agency computers, and/or customer computers, or some or all of the functionality may be integrated into a dedicated, standalone device. All such permutations and combinations are intended to fall within the scope of the present disclosure.

While the invention has been disclosed in connection with certain preferred embodiments, other embodiments will be recognized by those of ordinary skill in the art, and all such variations, modifications, and substitutions are intended to fall within the scope of this disclosure. Thus, the invention is to be understood with reference to the following claims, which are to be interpreted in the broadest sense allowable by law.

What is claimed is:

1. A method comprising:
acquiring ground transportation data from a plurality of service providers;
receiving travel itinerary data from a client;
applying the travel itinerary data to the ground transportation data to obtain a plurality of ground transportation options, each one of the plurality of ground transportation options including a transportation mode wherein the plurality of ground transportation options includes at least two different modes of transportation; and
transmitting the plurality of ground transportation options to the client for display in a ground transportation matrix that includes, for each one of the ground transportation options, an icon depicting the transportation mode, an estimated price for the transportation mode, and a link to additional information for the one of the ground transportation options.

2. The method of claim 1 wherein the additional information includes a number of ground transportation offerings from one of the plurality of service providers.

3. The method of claim 1 further comprising:
receiving a selection of one of the plurality of ground transportation options from the client, thereby providing a selected ground transportation service; and
preparing a travel itinerary that includes the selected ground transportation service.

4. The method of claim 3 further comprising booking the selected ground transportation service.

5. The method of claim 3 further comprising processing a payment for the selected ground transportation service.

6. The method of claim 3 further comprising storing the travel itinerary and providing an in-transit user interface for retrieving details of the travel itinerary.

7. The method of claim 6 wherein the in-transit user interface includes one or more of an electronic mail interface, a short messaging service interface, an instant messaging interface, and a web interface.

8. The method of claim 1 wherein the client includes a stand-alone consumer interface for booking ground transportation.

9. The method of claim 1 wherein the client includes a travel planning Web portal that provides a consumer interface for obtaining travel reservations.

10. The method of claim 1 wherein the at least two different modes of transportation include one or more of a bus, a taxi, a water taxi, a limousine, a subway, a rental car, and a commuter rail.

11. The method of claim 1 wherein the link to additional information for the one of the ground transportation options includes a link to one or more of a rental car company web site, a private car service web site, and a public transportation web site.

12. The method of claim 1 further comprising:
receiving a selection of one of the plurality of ground transportation options from the client, thereby providing a selected ground transportation service; and
adjusting a price for one or more providers of the selected ground transportation service based upon historical data, thereby providing adjusted prices; and
transmitting the adjusted prices to the client for display.

13. The method of claim 1 wherein the link to additional information for one of the ground transportation options provides a list of a plurality of service providers for the one of the ground transportation options.

14. The method of claim 1 further comprising sorting the plurality of ground transportation options in the ground transportation matrix according to one or more of cost and speed.

15. The method of claim 1 wherein applying the travel itinerary data to the ground transportation data to obtain a plurality of ground transportation options includes applying a corporate travel policy to determine available ground transportation options.

16. The method of claim 1 wherein applying the travel itinerary data to the ground transportation data to obtain a plurality of ground transportation options includes determining a membership of a user in a group, and using the membership to determine available ground transportation options.

17. The method of claim 1 wherein applying the travel itinerary data to the ground transportation data to obtain a plurality of ground transportation options includes determining a membership of a user in a group, and using the membership to locate one or more discounts for the plurality of ground transportation options.

18. A method of enforcing corporate travel policies comprising:
presenting a plurality of ground transportation alternatives to a user;
receiving a selection of one of the ground transportation alternatives from the user; and
selectively accepting the selection only when it conforms to a corporate travel policy.

19. The method of claim 18 wherein the corporate travel policy specifies a cost for ground transportation.

20. The method of claim 18 wherein the corporate travel policy specifies one or more providers of ground transportation service.
